(19) United States
(12) Patent Application Publication
(10) Pub. No.: US 2008/0062976 A1
(43) Pub. Date: Mar. 13, 2008

(54) System, method and apparatus for remote access to system control management within teamed network communication environments

(75) Inventors: Balaji Mittapalli, Austin, TX (US); Hendrich M. Hernandez, Round Rock, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 11/517,777

(22) Filed: Sep. 8, 2006

(51) Int. Cl. H04L 12/56; H04L 12/66

(52) U.S. Cl. 370/389; 370/463

(57) ABSTRACT

A system, method, and apparatus for accessing management control functions within a teamed network communication environment of an information handling system is disclosed. According to one aspect, an information handling system including an apparatus can include a teamed network interface operable to communicate network traffic local to the apparatus. The network traffic can include management access data packets and non-management access data packets. The apparatus can also include a first onboard local area network controller communicatively coupled to the teamed network interface and operable to receive a first management access data packet from the network traffic. The apparatus can further include a first data packet filter module provided in association with the first onboard local area network controller. The first data packet filter module can be operable to identify the first management access data packet and communicate the management access data packet to a management controller.

### FIELD OF THE DISCLOSURE

This disclosure relates generally to information handling systems, and more particularly to a system and method for remote access to system control management within teamed network communication environments.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

Various information handling systems can be provided as servers that allow for accessing and serving information, applications and data to multiple clients connected via an Intranet, the Internet, or any combination thereof. Managing servers and server configurations has historically been accomplished by system administrators accessing terminals placed in close proximity to an actual server. System administrators could modify software, hardware, and other configurations using the terminal. However, recent developments in the server management community have evolved to allow system administrator's access to servers from remote locations. For example, some conventional servers include remote management applications that allow system administrators to access server software, hardware, and various other server components from a remote terminal.

Access to management applications for conventional servers can be provided through a specific communication port of the server. For example, a server can be configured with a dedicated communication port that allows system administrators to log in through to manage servers from remote locations. However, advancements in network communication interfaces within server systems have been problematic for some servers using dedicated ports for administrative access. For example, some server systems that employ teamed network interfaces can drop incoming management data packets when a reliance on switch dependant teaming of incoming network traffic is used. As result, some management access data within network traffic may not be forwarded to management applications, which can result in loosing a connection to the management application. As such, there is a need to provide consistent remote access to server management applications within network teaming communication environments.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 illustrates a functional block diagram of an remote management access system according to another aspect of the disclosure;

FIG. 3 illustrates a flow diagram of a method for receiving network traffic including management access data packets according to a one aspect of the disclosure; and

FIG. 4 illustrates a flow diagram of a method for sending management data packets in association with a teamed network interface according to a further aspect of the disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As indicated above, the following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. For example, much of the following focuses on information handling systems having printed circuit boards with quality verification test structures and methods for testing test structures. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

According to one aspect of the disclosure, an information handling system including an apparatus can include a teamed network interface operable to communicate network traffic local to the apparatus. The network traffic can include management access data packets and non-management access data packets. The apparatus can also include a first onboard local area network controller communicatively coupled to the teamed network interface and operable to receive a first management access data packet from the network traffic. The apparatus can further include a first data packet filter module provided in association with the first onboard local area network controller. The first data packet filter module can be operable to identify the first management access data packet and communicate the first management access data packet to a management controller.

According to a further aspect of the disclosure, a method for providing access to a management system within an information handling system is provided. The method can include receiving network traffic operable to include a first management data packet and a first non-management data packet. The method can also include determining if the network traffic was received using a first onboard local area network controller. The method can also include detecting the first management data packet using a data packet filter module provided in association with a teaming interface operable to communicate network traffic local to an apparatus. The method can further include communicating the first management data packet within the network traffic to a management controller using the teaming interface.

According to a particular embodiment of the disclosure, an information handling system including can an apparatus having a teamed network interface operable to communicate network traffic operable to include management access data packets and non-management access data packets. The apparatus can also include a first onboard local area network controller communicatively coupled to the teamed network interface and operable to receive a first management access data packet from the network traffic. The apparatus can further include a first data packet filter module provided in association with the first onboard local area network controller. The first data packet filter module can be operable to identify the first management access data packet within the network traffic and communicate the first management access data packet to a management controller. The apparatus can also include a first network interface card operable to be associated as a teamed network communication device with the teamed network interface. The first network interface card can be operable to access a second data packet filter module of the teamed network interface in response to receiving the first management access data packet from a client. The apparatus can further include a second onboard local area network controller operable to be associated as a second teamed network communication device with the teamed network interface. The second onboard local area network controller can be operable to receive an outbound management data packet within the network traffic and from the second data packet filter module and transmit the outbound management data packet to the client.

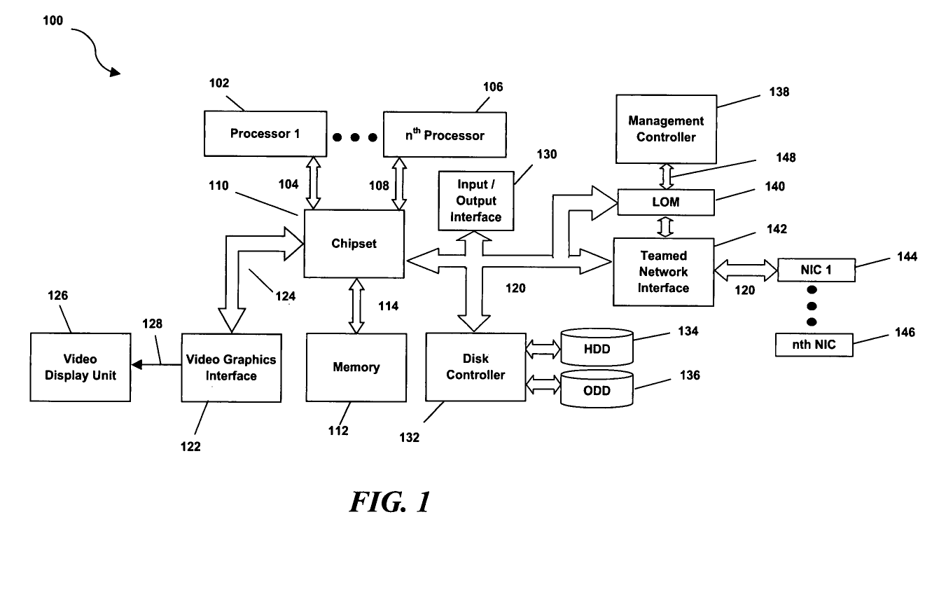

FIG. 1 illustrates a block diagram of an exemplary embodiment of an information handling system, generally designated at 100. In one form, the information handling system 100 can be a computer system such as a server. As shown in FIG. 1, the information handling system 100 can include a first physical processor 102 coupled to a first host bus 104 and further includes additional processors generally designated as n^{th} physical processor 106 coupled to a second host bus 108. The first physical processor 102 can be coupled to a chipset 110 via the first host bus 104. Further, the n^{th} physical processor 106 can be coupled to the chipset 110 via the second host bus 108. The chipset 110 can support multiple processors and allows for simultaneous processing of multiple processors and support the exchange of information within information handling system 100 during multiple processing operations.

According to one aspect, the chipset 110 can be referred to as a memory hub or a memory controller. For example, the chipset 110 can include an Accelerated Hub Architecture (AHA) that uses a dedicated bus to transfer data between first physical processor 102 and the n^{th} physical processor 106. For example, the chipset 110 including an AHA enabled-chipset can include a memory controller hub and an input/output (I/O) controller hub. As a memory controller hub, the chipset 110 can function to provide access to first physical processor 102 using first bus 104 and nth physical processor 106 using the second host bus 108. The chipset 110 can also provide a memory interface for accessing memory 112 using a third host bus 114. In a particular embodiment, the host buses 104, 108, and 114 can be individual buses or part of the same bus. The chipset 110 can also provide bus control and handles transfers between the host buses 104, 108, 114.

According to one aspect, the chipset 110 can be generally considered an application specific chipset that provides connectivity to various buses, and integrates other system functions. For example, the chipset 110 can be provided using an Intel® Hub Architecture (IHA) chipset also that can include two parts, a Graphics and AGP Memory Controller Hub (GMCH) and an I/O Controller Hub (ICH). For example, an Intel 820E, a 815E chipset, or combinations thereof, available from the Intel Corporation of Santa Clara, Calif., can provide at least a portion of the chipset 110. The chipset 110 can also be packaged as an application specific integrated circuit (ASIC).

According to one aspect, the information handling system 100 can include the chipset 110 coupled to a video graphics interface 122 using fourth host bus 124. In one form, a video graphics interface 122 can be provided as an Accelerated Graphics Port (AGP) interface to display content using a video display unit 126. The video graphics interface 122 can provide a video display content output 128 to the video display unit 126. The video display unit 126 can include one or more types of video displays such as a flat panel display (FPD) or other type of display device.

The information handling system 100 can also include an input/output interface 130 that may be connected via the fourth host bus 120 to the chipset 110. The input/output interface 130 can include industry standard buses or proprietary buses and respective interfaces or controllers. The fourth host bus 120 can also include a Peripheral Component Interconnect (PCI) bus or a high speed PCI-Express bus. A PCI bus can be operated at approximately 66 Mhz and a PCI-Express bus can be operated at approximately twice that rate or 128 Mhz. PCI buses and PCI-Express buses can be provided to comply with industry standards for connecting and communicating between various PCI-enabled hardware devices. Other buses can also be provided in association with, or independent of, the fourth host bus 120 including other industry standard buses or proprietary buses, such as ISA, SCSI, I2C, SPI, or USB buses.

In an alternate embodiment, the chipset 110 can be provided as a chipset employing a Northbridge/Southbridge chipset configuration (not expressly shown). For example, a Northbridge portion of the chipset 110 can communicate with the first physical processor 102 and can control interaction with the memory 112, the fourth bus 120 operable as a PCI bus, and activities for the video graphics interface 122. The Northbridge portion can also communicate with the first physical processor 102 using first bus 104 and the second bus 108 coupled to the n^{th} physical processor 106. The chipset 110 can also include a Southbridge portion (not illustrated) of the chipset 110 and can handle input/output (I/O) functions of the chipset 110. The Southbridge portion can manage the basic forms of I/O such as Universal Serial Bus (USB), serial I/O, audio outputs, Integrated Drive Electronics (IDE), and Industry Standard Architecture (ISA) I/O for the information handling system 100.

The information handling system 100 can further include a disk controller 132 coupled to the fourth bus 120. The disk controller 132 can be used to connect one or more disk drives such as a hard disk drive (HDD) 134 and an optical disk drive (ODD) 136 such as a Read/Write Compact Disk (R/W-CD), a Read/Write Digital Video Disk (R/W-DVD), a Read/Write mini-Digital Video Disk (R/W mini-DVD), or other type of optical disk drive.

The information handling system 100 can also include a management controller 138 operable to be coupled to a land area network on motherboard (LOM) controller 140 using a system management bus 148 of the information handling system. The LOM controller 140 can be coupled to the fourth bus 120 of the information handling system 100. In one form, the LOM controller 140 can be provided as a network controller that can include a chip or chipset embedded within information handling system's 100 motherboard (not expressly shown). The LOM controller 140 can be provided to handle network connections and communication of network traffic and can be used instead of, or in addition to, a traditional network interface card. The information handling system 100 can also include a first network interface controller (NIC) 144 coupled to the fourth bus 120 which can be operable as a PCI bus or PCI express bus. Providing the LOM controller 140 can free up or make available a PCI slot or bus interface of the information handling system 100 to further expand functionality as needed.

In one embodiment, the teamed network interface 142 can be provided as firmware or software interface that can be executed by an operating system of the information handling system 100 and can be used two provide the appearance that a signal network interface of the information handling system 100 when multiple communication devices or controllers can be employed. For example, network interface cards such as LOM controller 140, the first NIC 144, and the nth NIC 146 when teamed together by the teamed network interface 142 can work together and provide an appearance of being a single network connection. The teamed network interface 142 can also communicate local network traffic between various components of the information handling system 100. For example, the teamed network interface 142 can communicate network traffic received by the first NIC 144 to one or more devices within the information handling system as local network traffic. As such, local network traffic may be provided by the teamed network interface 142 internal to the information handling system 100.

In one form, the teamed network interface 142 can be coupled to multiple communication devices, such as LOM controller 140, the first NIC 144, and the nth NIC 146 and can provide the appearance as being a single communication device. The teamed network interface 142 can then be used to load balance network traffic of the information handling system 100 when communicating data to an external network such as an Intranet or the Internet. The teamed network interface 142 can operate to increase hardware fault tolerance levels of network communication devices of the information handling system 100. As such, if either as LOM controller 140, the first NIC 144, or the nth NIC 146 fails or becomes faulty, the network traffic for the information handling system 100 can continue using the remaining network communication devices operably associated with the teamed network interface 142.

During operation of the information handling system 100, the teamed network interface 142 can be provided to support sharing of various network communication devices, such as the LOM controller 140, the first NIC 144, the nth NIC 146, or various combinations thereof. The network traffic can be provided by an external network such as an Intranet or the Internet and can include host network traffic and out-of-band system management traffic. For example, the network traffic can include management access data packets that can be provided to access the management controller 138 and non-management data access packets provided for various other applications that can be used by the information handling system 100. In one embodiment, the teamed network interface 204 can be provided within an operating system of the information handling system 100.

In one form, network traffic including a management access data packet can be received by a team member or teamed network communication device of the teamed network interface 144. The teamed network communication device can forward the management access data packet to the teamed network interface 204. For example, the first NIC 144 can be associated as a teamed network communication device of the teamed network interface 142. As such, the network traffic received by the first NIC 144, and including the management access data packet can be provided to the teamed network interface 142. The teamed network interface 142 can then filter the management access data packet and forward the management access data packet to the management controller 138. For example, the management access data packets can be forwarded using the LOM controller 140 and the system management bus 148. In another aspect, the LOM controller 140 may not be available and the teamed network interface 142 can provide the management data packet to the memory 112 operable to store an OS stack. The management access data packet can then be forwarded to the system management bus 148 and the management controller 138. In this manner, a management access data packet can be received in association with network traffic using the teamed network interface 142 and forwarded to the management controller 138 providing access to management features or functions of the information handling system 100.

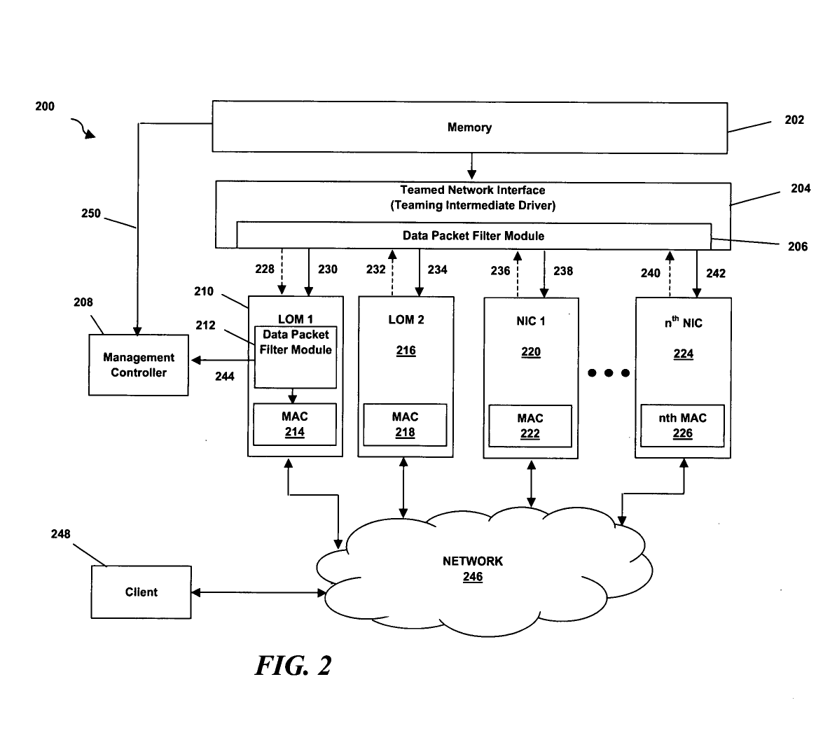

FIG. 2 illustrates a functional block diagram a remote management access system, generally depicted at 200, according to aspect of the disclosure. The remote management access system 200 can be employed by the information handling system 100 illustrated in FIG. 1 or other types of information handling systems that can benefit from one or more features or functions of the remote management access system 200. In one form, the remote management access system 200 can be considered an information handling system.

According to one aspect of the disclosure, the remote management access system 200 can include a memory 202 operable associated with an operating system and can include a memory stack that can be used to store information such as data packets communicated within network traffic and can be accessible by an operating system (not expressly shown) of an information handling system. The memory 202 can be coupled to a teamed network interface 204 that can include a data packet filter module 206 operable to communicate data using one or more communication devices or modules that can be operably associated with the remote management access processing system 200. Remote management access system 200 can also include a memory controller 208 operable to provide system level access for managing an information handling system.

In one embodiment, the data packet filter module 206 and management controller 208 can be provided as an Intelligent Platform Management Interface (IPMI) enabled filter. For example, IPMI includes a specification for equipment that monitors the physical environment and behavior of an information handling system. IPMI can be used with hardware servers regardless of an operating platform, OS or other software employed by the information handling system. IPMI allows an administrator to manage multiple servers from a single location by means of a user-friendly interface.

In another embodiment, the remote management access system 200 can include a first onboard local area network controller or a first LOM controller 210. The first LOM controller 210 can include a second data packet filter module 212 and a first machine access code (MAC) 214 that can be used to identify the first LOM controller 210. The second data packet filer module 212 can be provided as an IPMI enabled filter. In one form, the first data packet filter module 206 and the second data packet module 212 can be used as bi-directional filters operable to send and receive data packets such as network traffic that can include management access data packets and non-management access data packets. The remote management access system 200 can further include a second LOM controller 216 including a second MAC 218, and a first NIC 220 including a third MAC 222. Additional network interface cards can also be provided as illustrated by n^{th} NIC 224 having an n^{th} MAC 226.

In one form, first LOM controller 210 can be connected to the teamed network interface 204 using a first communication port 228 and a second communication port 230. Additionally, the second LOM controller 216 can be connected to the teamed network interface 204 using a third communication port 232 and a fourth communication port 234, and the first NIC 220 can be connected to the teamed network interface 204 using the fifth communication port 236 and the sixth communication port 238. The nth NIC 224 can be coupled to the teamed network interface 204 using at seventh communication port 240 and an eighth communication port 242. First LOM controller 210 can also be connected to a management controller 208 via a system management bus 244. In one form, the memory 202 may be coupled to the management controller 208 using a chipset bus 250 operable to provide access to the memory 202. For example, the management controller 208 may be coupled to the memory 202 using a chipset such as the chipset 110 illustrated in FIG. 1 and an associated bus. In one embodiment, the first LOM controller 210 can be provided as a shared onboard local area network controller that can be coupled to the management controller 208 and the teamed network interface 204 for communicating data packets. According one aspect, one or more of the first LOM controller 210, the second LOM controller 216, the first NIC 220, and the nth NIC 224, can be coupled to a network 246 operable to provide a client 248 remote access to the remote management access system 200 via the Internet or an Intranet.

During operation, the remote management access system 200 can be operable to support sharing of various network communication devices, such as the first LOM controller 210, the second LOM controller 216, the first NIC 220, and/or the nth NIC 224 using the teamed network interface 204 to provide a teamed communication environment. The remote management access system 200 can support transferring network traffic that can include host network traffic and out-of-band system management traffic. For example, the network traffic can include management access data packets and non-management data access packets. According to one aspect, the teamed network interface 204 can be provided within an operating system of an information handling system and can include switch dependent teams of network communication devices for communicating network traffic. For example, a 802.3ad enabled device or link aggregation device such, or a Fast Ethernet Channel (FEC) or Gigabyte Ethernet Channel (GEC) enabled device can be configured using the teamed network interface 204 provided between network communication devices or controllers such as the first LOM controller 210, the second LOM controller 216, the first NIC 220, and the nth NIC 224.

The teamed network interface 204 can randomly forward the incoming management and non-management network traffic onto network adapters or controllers such as the first LOM controller 210, the second LOM controller 216, the first NIC 220, and the nth NIC 224 that may be participating as a teamed network communication device. In one form, a management data access packet may be received by a teamed network communication device. The teamed network communication device can forward the management access data packet to the teamed network interface 204. For example, the teamed network interface 202 can include the first data filter module 206 that can detect if management access data packets have been forwarded by a team member to the teamed network interface 202. The teamed network interface 202 using the first data filter module 206 can filter the management access data packets received by the teamed network interface 202 and forward the management access data packets to the management controller 208. For example, the management access data packets can be forwarded using the first LOM controller 210 and the system management bus 244. In another form, if the first LOM controller 210 may not be available, the teamed network interface 202 can provide the management data packets to the memory or OS stack 202 to be forwarded to the chipset bus 250 and the management controller 208.

In another embodiment, the teamed network interface 204 can provide a network team configured in the OS 202 between the first LOM controller 210 provided as a shared LOM controller. The teamed network communication devices can include one or more of the second LOM controller 216, the first NIC 220, and the nth NIC 224 that can be connected to the teamed network interface 204 and operable to receive network traffic. The first data packet filter module 206 in teamed network interface 204 can filter out the management access data packets and forward the management access data packets to the second data packet filter module 212 in the first LOM controller 210. The second data packet filter module 212 can then be used to forward the management access data packet to management controller 208 accordingly.

In a further embodiment, the teamed network interface 204 can learn a MAC address for the management controller 208 from the first LOM controller 210. The MAC address of the management controller 208 can then be communicated to teamed devices coupled to the teamed network interface 204 using a MAC address table. For example, one or more of the teamed devices, such as first LOM controller 210, second LOM controller 216, the first NIC 220, or n^{th} NIC 224 can be coupled to the teamed network interface 204 as a teamed network communication device and can include software, such as a driver, that can be periodically updated by the teamed network interface 204. As such, the teamed network interface 204 can provide valid MAC addresses for various devices coupled to the teamed network interface 204. For example, the teamed network interface 204 can communicate a MAC address table to each teamed network communication device that can be used to update a driver or other memory device of a teamed network communication device. In this manner, a teamed network communication device can be provided a valid MAC address of the management controller 208 and other devices for communicating network traffic.

According to one aspect, a management access data packet can arrive as network traffic to a teamed communication device other than first LOM controller 210. For example, the network traffic including a management access data packet can be received by the second LOM controller 216, the first NIC 220, or the n^{th} NIC 224. The teamed communication device can then access the data packet filter module 206 of the teamed network interface 204 and the management data access packet can be filtered out of the network traffic by the data packet filter module 206 and forwarded to the management controller 208. In one embodiment, the filtered management data packet can be filtered by the data packet filter module 206 and communicated to the first LOM controller 210 through first communication port 228. The first LOM controller 210 can then communicate the filtered management data access packet to the management controller 208 using the system management bus 244. In this manner, management access data packets can be received in a teamed network communication environment and communicated to the management controller 208 as needed.

In one embodiment, the remote management access system 200 can support management connection redundancy when the first LOM controller 210 fails. For example, if the first LOM 210 controller fails or connectivity may be lost, one or more of the teamed network interface devices, such as second LOM controller 216, first NIC 220, or n^{th} NIC 224 can be used to communicate network access management data packets. The teamed network interface 204 employing the data packet filter module 206 can filter the management access data packets and determine if the first LOM controller 210 can be available to forward the management data packets to the management controller 208. If the first LOM controller may not be available, the teamed network interface 204 can provide the management data packets to the memory 202 that may be operable as an OS stack operable to provide the management access data packets to the management controller 208 using the chipset bus 250. In this manner, system redundancy can be realized with the remote management access system 200.

In another embodiment, an operating system can be functional or running. As such, the teamed network interface 204 may not be functioning or enabled. However, the first LOM controller 210 employing the second data packet filter module 212 can filter management access data packets and communicate the management access data packets to the management controller 208 as needed. In this manner, if an operating system or other operating environment that can be used to provide the teaming network interface 204 may not be functional, management access data packets can be communicated to the management controller 208.

In one form, portions or all of the remote access management system 200 can be provided within firmware, software or various components provided within an information handling system. For example, the teamed network interface 204 can be provided within firmware or software and need only be updated to include a first data packet filter module 206 provided as firmware or software that can be accessed by the teamed network interface. For example, a driver can be provided for the teamed network interface 204, the first data packet filter module 206, or any combination thereof, and can be operable to detect management data packets within the network traffic communicated in a teamed environment and communicate the management access data packets to the management controller 208. As such, teamed network interface providers and vendors can provide software or firmware to enable remote access to the management controller 208. In other embodiments, software or firmware updates for the remote access management system 200 and various components can be provided after installation and can be downloaded as a driver from a vendor or provider as needed.

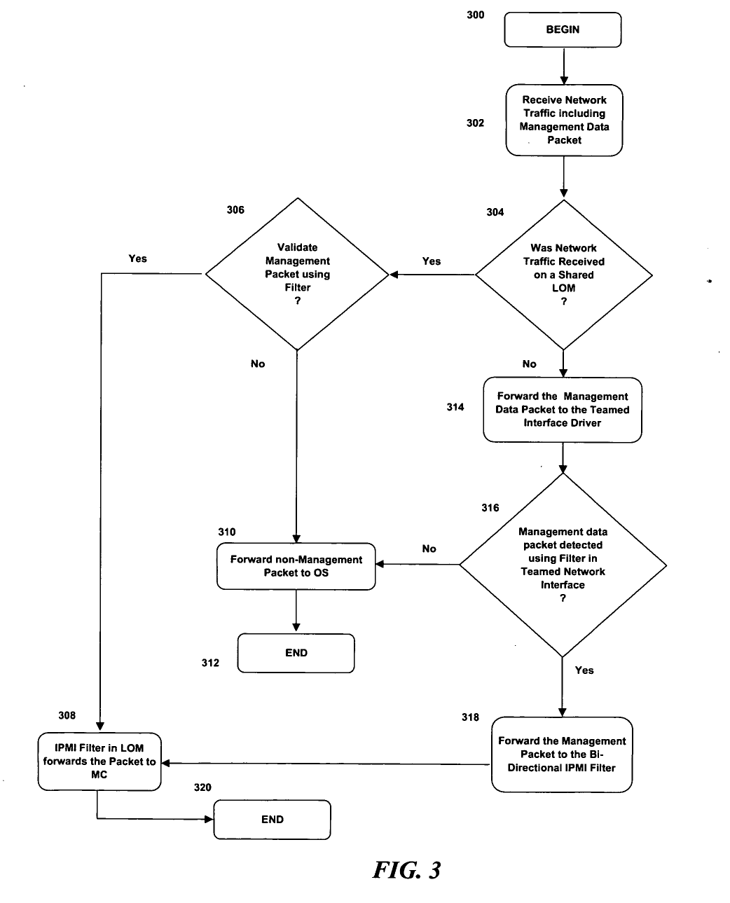

FIG. 3 illustrates a flow diagram of a method for receiving network traffic including management access data packets according to one aspect of the disclosure. The method of FIG. 3 can be employed in whole or in part by the information handling system 100 depicted in FIG. 1, the remote access management system 200 illustrated in FIG. 2, or any other type of information handling system operable to employ the method of FIG. 3. Additionally, the method can be embodied in various types of logic-encoded media including software, firmware, hardware, or other forms of digital storage mediums or logic operable to provide all or portions of the method of FIG. 3.

The method begins generally at step 300. At step 302, network traffic can be received by an information handling system operable to be coupled to a network such as a local area network (LAN), an Intranet, the Internet, or any combination thereof. The network traffic can include various types of information and in one form can include management data packets operable to be used in association with a management controller for remote access by a client system. Upon receiving network traffic, the method proceeds to decision step 304 and determines if the network traffic was received using a shared onboard local area network controller, such as a shared LOM controller. For example, a shared LOM controller can be operable to receive a management data packet and forward the management data packet directly to a management controller via a system management bus. As such, a management data packet can be received by the shared LOM controller. The method can then proceed to decision step 306 and the shared LOM controller can employ a filter to determine if a management data packet has been received within the network traffic. For example, the shared LOM controller can employ a filter operable to detect a MAC address of a management controller of an information handling system has been requested. Upon validating the management access data packet at decision step 306, the method can then proceed to step 308 where the detected management data packet can be forwarded to the management controller in the information handling system. In one form, the management data packet can be forwarded to the management controller using a system management bus operable to provide access to a management controller. The method can then proceed to step 320 where the method ends or repeats at step 300 when network traffic including management access data packets can be received.

In one embodiment, at decision step 306, a data packet detected by the filter within the shared LOM controller may not be a management access data packet. As such, the method can proceed to step 310 and the non-management data packet can be forwarded to the operating system memory or OS stack of the information handling system for processing as needed. The method can then proceed to step 312 where the method ends or repeats at step 300 when network traffic that can include management data packets can be received.

In another embodiment, if at decision step 304 network traffic was not received using the shared LOM controller and was received by another LOM controller or a NIC provided in association with an information handling system, the method can proceed to step 314. At step 314, the network traffic including the management access data packet can be communicated to a teamed interface driver. For example, a teamed interface driver can be provided within a teamed network interface. The method can then proceed to decision step 316 and determines if a management access data packet can be detected within the network traffic using a filter within the teamed network interface. For example, the teamed network interface can be coupled to several network communication devices and in one embodiment can be coupled to at least one LOM controller and one NIC. The teamed network interface can be operable to load balance network traffic during increased network activity to level out network traffic within an information handling system.

If at decision step 316, a management access data packet can not be detected, the method can proceed to step 310 and the method can communicate or forward the non-management packet to the memory or operating system of the information handling system for subsequent processing or use. The method can then proceed to step 312. If at decision step 316, the method detects a management access data packet within the network traffic using a filter within the teamed network interface, the teamed network interface can proceed to step 318 and the management access data packet can be forwarded to a filter of the teamed network interface. For example, the teamed network interface can employ a bi-directional filter that can allow for sending and receiving management access data packets using the teamed network interface. The bi-directional filter can be an IPMI enabled filter operable to be used in association with a management controller. The method can then proceed to step 308 and an IPMI enabled filter within the shared LOM controller can forward the management data packet to the management controller. The method can then proceed to step 320 and where the method ends. In this manner, management access data packets can be received within network traffic by a shared LOM controller or other network device or interface used in association with a teamed network interface and can be forwarded to management controller of an information handling system.

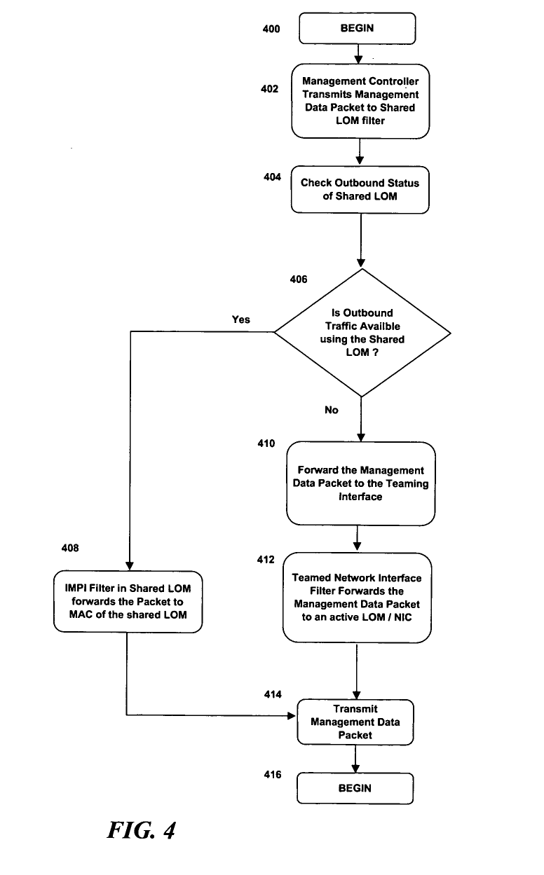

FIG. 4 illustrates a flow diagram of a method for sending management data packets in association with a teamed network interface according to one aspect of the disclosure. The method of FIG. 4 can be employed in whole or in part by the information handling system 100 depicted in FIG. 1, the remote access management system 200 illustrated in FIG. 2, or any other type of information handling system operable to employ the method of FIG. 4. Additionally, the method can be embodied in various types of logic-encoded media including software, firmware, hardware, or other forms of digital storage mediums or logic operable to provide all or portions of the method of FIG. 4.

The method begins generally at step 400. At step 402, a management controller of the information handling system provides and outbound management data packet to be sent to a client requesting access to the management controller. The outbound management data packet can be transmitted to the shared LOM controller coupled to a management controller using, for example, a system management bus of an information handling system. At step 402, the outbound management data packet can be sent to a filter within the shared LOM controller operable to detect an outbound communication including a management data packet. The method can proceed to step 404 and the outbound status of the shared LOM controller can be checked to determine if network traffic can be transmitted my the shared LOM controller to a client. For example, the shared LOM controller can include a bi-directional filter operable to determine if outbound traffic can be communicated using the shared LOM controller and at decision step 406, if outbound traffic can be communicated using the shared LOM controller, the method proceeds to step 408 and the outbound management data packet can be transmitted using the MAC address of the shared LOM controller. The shared LOM controller can then communicate the outbound management data packet to the client.

If at decision step 406, the method can determine if the shared LOM controller may not be available to communicate an outbound management data packet. If the shared LOM controller is unavailable, the method can proceed to step 410 and the outbound management data packet can be forwarded to the teamed network interface. For example, the teamed network interface can include a filter operable to receive outbound management data traffic. At step 410, the outbound management data packet can be forwarded to the teamed network interface and at step 412, the teamed network interface can determine an active device to forward the management data packet to for transmitting to the client and can use a MAC address of the active team device to forward the outbound management data packet. For example, the teamed network interface can include multiple team members or network communication devices provided within an information handling system and accessible to the teamed network interface.

In one form, network communication devices such as onboard local area network controller or LOM controller, NICs, or other communication modules, or other wireline or wireless devices that can participate or be coupled to a teamed network interface for sending or transmitting outbound data packets to a network. As such, at step 412 the teamed network interface can forward the outbound management data packet to an active team member using the MAC address of the active team member. The method can then proceed to step 414 and the outbound management data packet can be transmitted to the network using the active teamed device. The method can then proceed to step 416 and end.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system including an apparatus comprising:
a teamed network interface operable to communicate network traffic local to the apparatus, the network traffic including management access data packets and non-management access data packets;
a first onboard local area network controller communicatively coupled to the teamed network interface and operable to receive a first management access data packet from the network traffic; and
a first data packet filter module provided in association with the first onboard local area network controller, the first data packet filter module operable to identify the first management access data packet and communicate the management access data packet to a management controller.

2. The system of claim 1, wherein the first data packet filter module is operable to send and receive the network traffic.

3. The system of claim 1, wherein the first onboard local area network controller further comprises a shared onboard local area network controller operable to communicate with the teamed network interface and the management controller.

4. The system of claim 1, wherein the apparatus further comprises a system management bus operable to communicate the management data packets between the management controller and the first data packet filter module.

5. The system of claim 1 wherein the first data packet filter module is operable to receive the first management data packet from the teamed network interface, the teamed network interface communicatively coupled to a first teamed network communication device.

6. The system of claim 5, wherein the teamed network interface includes a second data packet filter module operable to detect management data packets within the network traffic received in association with the first teamed network communication device.

7. The system of claim 6, wherein the apparatus further comprises a second onboard local area network controller communicatively coupled to the teamed network interface and operable to receive a portion of the network traffic, the second onboard local area network controller further operable to access the second data packet filter module to identity the first management access data packet.

8. The system of claim 1, further comprising:
a first network interface card communicatively coupled to the teamed network interface and operable to access a second data packet filter module of the teamed network interface in response to receiving the first management access data packet; and
a second onboard local area network controller communicatively coupled to the teamed network interface and operable to access the second data packet filter module in response to receiving a second management access data packet.

9. The system of claim 8, wherein the apparatus further comprises a machine access code (MAC) address table provided within a memory of the first onboard local area network controller and the teamed network interface, the MAC address table including:
a first MAC address provided in association with the first onboard local area network controller;
a second MAC address provided in association with the second onboard local area network controller;
a third MAC address provided in association with the first network interface card; and
a fourth MAC address provided in association with the management controller.

10. The system of claim 9, further comprising:
the first data packet filter module operable to receive an outgoing data packet from the management controller as an outbound management data packet, the first data packet filter module operable to determine a communication status of the first onboard local area network controller;
the first data packet filter further operable to communicate the outbound management data packet to the teamed network interface in response to not having access to the first onboard local area network controller to transmit the outbound management data packet to a client;
the teamed network interface operable to receive the outbound management data packet and determine an availability of the first teamed network communication device;
the second data packet filter operable modify the outbound management data packet to include a MAC address of an available teamed network communication device; and
the teamed network interface operable to communicate the modified outbound management data packet to the teamed network communication device.

11. A method for providing access to a management system within an information handling system comprising the steps of:
receiving network traffic operable to include a first management data packet and a first non-management data packet;
determining if the network traffic was received using a first onboard local area network controller;
detecting the first management data packet using a data packet filter module provided in association with a teaming interface operable to communicate network traffic local to an apparatus; and
communicating the first management data packet within the network traffic to a management controller using the teaming interface.

12. The method of claim 11 further comprising:
receiving of the network traffic using the first onboard local area network controller; and
communicating the first management data packet to the management controller using the first onboard local area network controller.

13. The method of claim 12 further comprising:
detecting the first non-management data packet using the first data packet filter module; and
communicating the first non-management data packet via the network teaming interface to a memory.

14. The method of claim 13 further comprising:
receiving the network traffic using a second data packet filter module;
detecting the first management data packet using the second data packet filter module; and
communicating the detected management data packet within the network traffic to the first onboard local area network controller operable to communicate the first management data packet to the management controller.

15. The method of claim 13 further comprising:
providing an outbound management access data packet operable to be transmitted to a client coupled to an external network;
detecting an availability of the first onboard local area network controller; and
communicating the outbound management data packet to the client in response to the availability.

16. The method of claim 15 further comprising:
determining an outbound status of the first onboard local area network controller using the first data packet filter module;
associating a machine access code (MAC) address of the first onboard local area network controller with the outbound management data packet;
communicating the outbound management data packet within the network traffic using the MAC address; and
receiving the outbound data management data packet at the first onboard local area network controller; and
transmitting the outbound management data packet to the client using the first onboard local area network controller.

17. The method of claim 15 further comprising:
determining if the first onboard local area network controller is unavailable;
forwarding the outbound management data packet within the network traffic to the teamed network interface;
determining an active teamed network communication device provided in association with the teamed network interface;
associating a MAC address of the active teamed network communication device with the outbound management data packet using the second data packet filter module; and
communicating the outbound management data packet via the second data packet filter to the active teamed network communication device using the MAC address.

18. The method of claim 17 further comprising:
receiving the outbound management data packet at the active teamed network communication device; and
transmitting the outbound management data packet to the client using the active teamed network communication device.

19. The method of claim 18 further comprising:
receiving the outbound management data packet at plural teamed network communication devices;
accessing a MAC address list within the plural teamed network communication devices to determine a valid teamed network communication device member operable to receive the outbound management data packet;
transmitting the outbound management data packet using the valid teamed network communication device; and
ignoring the outbound data packet if the MAC address is not valid.

20. An information handling system including an apparatus comprising:
a teamed network interface operable to communicate network traffic operable to include management access data packets and non-management access data packets;
a first onboard local area network controller communicatively coupled to the teamed network interface and operable to receive a first management access data packet from the network traffic;
a first data packet filter module provided in association with the first onboard local area network controller, the first data packet filter module operable to identify the first management access data packet within the network traffic and communicate the first management access data packet to a management controller;
a first network interface card operable to be associated as a teamed network communication device with the teamed network interface, the first network interface card operable to access a second data packet filter module of the teamed network interface in response to receiving the first management access data packet from a client; and
a second onboard local area network controller operable to be associated as a second teamed network communication device with the teamed network interface, the second onboard local area network controller operable to receive an outbound management data packet within the network traffic and from the second data packet filter module and transmit the outbound management data packet to the client.
